(19) United States
(12) Patent Application Publication
(10) Pub. No.: US 2026/0238141 A1
(43) Pub. Date: Aug. 13, 2026

(54) MITIGATION OF CIRCULATING CURRENTS IN PARALLELED POWER CONVERTERS HAVING COMMON DC LINK

(71) Applicant: Eaton Intelligent Power Limited, Dublin (IE)

(72) Inventors: Hua Qiang Li, Menomonee Falls, WI (US); Wenxi Yao, Hangzhou (CN); Zhihao Song, Hangzhou (CN)

(21) Appl. No.: 19/053,101

(22) Filed: Feb. 13, 2025

(51) Int. Cl. H02M 7/537

(52) U.S. Cl. CPC H02M 7/537

(57) ABSTRACT

A system includes: a drive module including an input, an output, and a plurality of power converters in parallel, each power converter including: an inverter electrically connected to the output of the drive module, the inverter including a plurality of controllable switches configured to switch at a switching frequency; and a common direct current (DC) link electrically connected to the inverter of each power converter; and a control apparatus coupled to the drive module, the control system configured to mitigate a plurality of circulating currents.

### TECHNICAL FIELD

This disclosure relates to mitigation of circulating currents in paralleled power converters that share a common DC link.

### BACKGROUND

An electrical apparatus, such as a variable speed drive (VSD), an adjustable speed drive (ASD), or an uninterruptable power supply, may be connected to an alternating current (AC) high-power electrical distribution system, such as a power grid. The electrical apparatus drives, powers, and/or controls a machine, or a non-machine type of load and can also convert direct current (DC) power to AC power. The source of DC power can be, for example, energy storage, batteries, photovoltaic (PV) solar and/or other renewable sources, or another AC to DC power converter. The electrical apparatus includes an electrical network that converts AC power to direct-current (DC) power and may also convert DC power to AC power.

### SUMMARY

In one aspect, a system includes: a drive module including an input, an output, and a plurality of power converters in parallel, each power converter including: an inverter electrically connected to the output of the drive module, the inverter including a plurality of controllable switches configured to switch at a switching frequency; and a common direct current (DC) link electrically connected to the inverter of each power converter; and a control apparatus coupled to the drive module, the control system configured to mitigate a plurality of circulating currents.

Implementations may include one or more of the following features.

The plurality of circulating currents may include a circulating current associated with the switching frequency and a circulating current associated with an operating frequency of a load electrically connected to the drive module. The circulating current associated with the switching frequency may include a cross-circulating current; and the circulating current associated with the operating frequency may include: one or more phase circulating currents, each phase circulating current flowing in one phase of the plurality of power converters and the common DC link; and a zero-sequence circulating current.

The control apparatus may be configured to mitigate a high-frequency circulating current and a low-frequency circulating current. To mitigate the high-frequency circulating current, the control apparatus may be configured to minimize an electrical feedback quantity, and the electrical feedback quantity may be based on a difference in an electrical output in one phase of each of the plurality of inverters. The electrical output may include an output current. To mitigate the high-frequency circulating current, the control apparatus may be configured phase shift a carrier wave associated with one of the plurality of inverters relative to the carrier wave associated with at least one other of the plurality of inverters. To compensate for the low-frequency circulating current, the control system may be configured to minimize a difference in an observed o-axis current. To compensate for the low-frequency circulating current, the control system may be further configured to minimize a difference between an observed output of each inverter and a reference based on the sum of the outputs of all of the inverters. The observed output may be an as output current.

In another aspect, a control apparatus includes: a cross-circulating current compensation module configured to: access a measured value of an electrical quantity at each of a plurality of inverters, all of the plurality of inverters electrically connected to a common DC link; determine a difference between the accessed measured values; determine a compensation based on the determined difference; and adjust a carrier wave of one or more of the plurality of inverters based on the determined compensation. The control apparatus also includes an operating frequency circulating current compensation module configured to reduce an amount of circulating current at an operating frequency of a load electrically connected to the plurality of inverters.

Implementations may include one or more of the following features.

The compensation may include a phase shift, and to adjust the carrier wave of one or more of the plurality of inverters, the cross-circulating current compensation module may be configured to delay or advance the carrier wave of one or more of the plurality of inverters by the phase shift.

The cross-circulating current compensation module may be further configured to minimize the difference between the accessed measured values and to determine the compensation based on the minimized difference.

In another aspect, a measured value of an electrical quantity at an output of each of a plurality of inverters is accessed, all of the plurality of inverters are electrically connected to a common DC link; a difference between the accessed measured values is determined; a compensation based on minimizing the difference between the accessed measured values is determined; a control signal for one or more of the plurality of inverters based on the compensation is adjusted; and the adjusted control signal is provided to the one or more of the plurality of inverters to reduce the difference between the electrical quantity at the outputs of the inverters.

Implementations may include one or more of the following features.

The electrical quantity may include a three-phase current at an output of each of the plurality of inverters, and, after providing the adjusted control signal to the one or more of the plurality of inverters, any one phase of the three-phase output current at a first one of the plurality of inverters is substantially the same in amplitude and phase as that same one phase at any other of the plurality of inverters.

In another aspect, a control system for a drive module includes a plurality of parallel inverters electrically connected to a common direct current (DC) link, the control system configured to: sample a circulating current in each phase of the drive module in response to detecting a peak of a first carrier wave and in response to detecting a minimum of the first carrier wave; determine an average circulating current based on the sampled circulating currents; and reduce the circulating current in the drive module by applying a compensation based on the average circulating current.

Implementations may include one or more of the following features. The first carrier wave may be a carrier wave used to determine a gate signal for a first one of the plurality of inverters; the control system may be further configured to determine the compensation, and the compensation may include a time difference between the first carrier wave and a second carrier wave used to determine a gate signal for a second one of the plurality of inverters; and to reduce the circulating current in the drive module, the second carrier wave is adjusted to reduce the time difference. The second carrier wave may be adjusted by being delayed or advanced by the time difference.

To sample the circulating current in each phase, the control system may be configured to: record the circulating current in one phase in response to detecting the peak of the first carrier wave; record the circulating current in the one phase in response to detecting the minimum of the first carrier wave; monitor a reference wave associated with the one phase relative to a pre-determined condition; and transition to sample the circulating current in another phase when the pre-determined condition is met. The circulating current may be sampled over one cycle, and a transition occurs six times during the cycle.

Implementations of any of the techniques described herein may include an apparatus, a device, a system, a control system, machine-executable instructions, and/or a method. The details of one or more implementations are set forth in the accompanying drawings and the description below. Other features will be apparent from the description and drawings, and from the claims.

### DRAWING DESCRIPTION

FIG. 1 is a block diagram of an example of a power system.

FIG. 2 is a schematic of an example of a system.

FIG. 3A is a block diagram of an example of a control scheme.

FIG. 3B is an example of a coordinate system.

FIG. 4 is a graphical example of switching events as a function of time of any one of the three phases in each inverter in the system of FIG. 2.

FIG. 5 is a block diagram of a compensation block that may be part of the control scheme of FIG. 3A.

FIG. 6 shows an example of phase reference signals over a single period (360°) of the operating frequency of a load.

FIG. 7 is a state machine for sampling inverter output currents based on the reference signals of FIG. 6.

FIG. 8 is a flowchart of an example of a process for controlling current to a load and removing or reducing circulating currents in a drive apparatus that includes N paralleled inverters that share a common DC link, where N is an integer number that is greater than or equal to two.

FIG. 9 shows simulated results from a simulated system.

### DETAILED DESCRIPTION

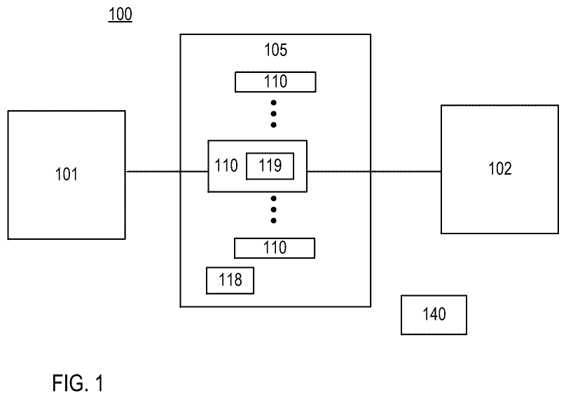

FIG. 1 is a block diagram of an example of a power system 100. The power system 100 includes a drive apparatus 105 that is electrically connected to a source 101 and a load 102, and a control system 140. As discussed below, the control system 140 compensates for, mitigates, and/or eliminates circulating currents in the drive apparatus 105.

The load 102 is any type of device or system that utilizes, transfers, absorbs, or distributes time-varying (or AC) electricity. The load 102 may be, for example, a motor (such as an induction motor), a lighting system, a machine, or a generator. The load 102 may take other forms. For example, the load 102 may be an AC power grid, an AC to DC power converter, an AC to AC power converter, just to name a few. The source 101 is any type of source of alternating current (AC) or time-varying electrical power. For example, the source 101 may be a node in an AC power grid or distribution network, an AC generator, or an output of an AC electrical apparatus, such as a DC to AC power converter, a transformer, or a voltage regulator.

The drive apparatus 105 includes N power converters 110, where N is a positive integer number that is equal to or greater than two. Each of the N power converters 110 may be, for example, an adjustable speed drive (ASD). The N power converters 110 are connected in parallel and are electrically connected to a common direct current (DC) link 118. The DC link 118 is any type of device that is capable of storing electrical energy. For example, the DC link 118 may include one or more capacitors. Each of the N power converters 110 also includes an inverter 119. Each inverter 119 includes a plurality of controllable semiconductor switches, each of which may be, for example, an insulated gate bipolar transistor (IGBT) or a metal-oxide-semiconductor field-effect transistor (MOSFET). Additionally, each inverter 119 includes an inductor at each of the output phase.

Connecting the N power converters 110 in parallel promotes modularity and redundancy. For example, if one of the N power converters 110 fails, the remaining power converters 110 continue to power the load 102 until the failed power converter is repaired or replaced. Additionally, the drive apparatus 105 delivers more power than a single power converter.

Although all of the N power converters 110 are identical, the parameters of the N power converters 110 are not exactly the same. This is due to, for example, differences in the components of the N power converters 110 that arise during manufacture and/or assembly. For example, the controllable semiconductor switches in the inverters 119 have a rise time and fall time. Although all of the semiconductor switches are nominally the same, the rise time and fall time of the individual switches vary to within the manufacturing tolerance of the switch. Thus, although all of the inverters 119 are nominally identical, in practice, some or all of the controllable semiconductor switches in the various inverters 119 may have different rise and/or fall time. Other parameters that may vary among the N power converters 110 include, without limitation, pulse with modulation (PWM) phase shift, deadtime, and the actual inductance of the inductor at the output of each inverter 119 phase.

Due to these variations, the outputs of the N inverters 119 are not necessarily identical even when commanded in the same manner, resulting in circulating currents that may exist at the frequency of operation of the load 102 and at the inverter 119 switching frequency. The circulating currents may create unequal current sharing between paralleled inverters 119, overstressing the power converters 110, and/or causing reliability and performance issues. On the other hand, the control system 140 causes the controllable semiconductor switches to change state or switch in a manner that reduces or eliminates the circulating current at both the load operating frequency and the circulating current at the inverter switching frequency. In this way, the control system 140 improves the overall performance of the drive apparatus 105 and the system 100.

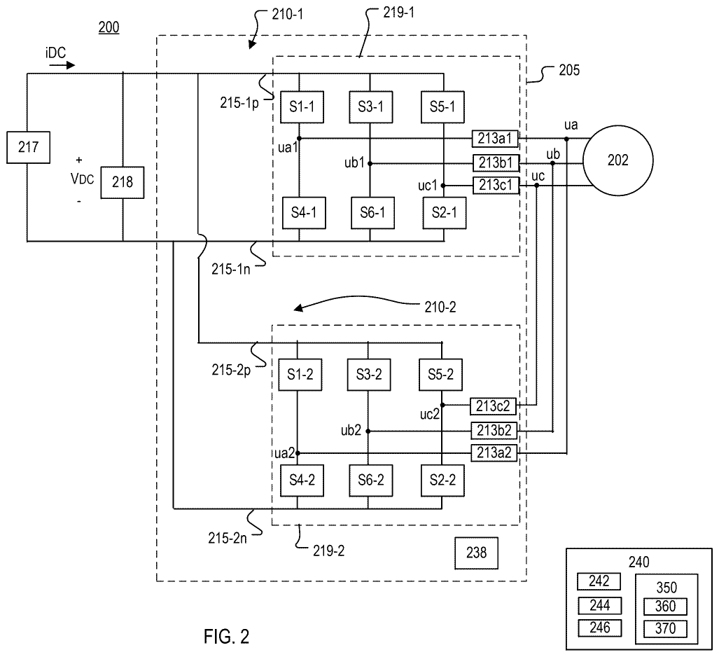

FIG. 2 is a schematic of a system 200. The system 200 includes a drive apparatus 205 that is connected to DC current source 217 and to a three-phase load 202. The drive apparatus 205 includes a first power converter 210-1 and a second power converter 210-2. The first power converter 210-1 includes an inverter 219-1, and the second power converter 210-2 includes an inverter 219-2. The inverter 219-1 and the inverter 219-2 are connected to each other in parallel. The power converter 210-1 includes a positive DC bus 215-1p and a negative DC bus 215-1n. The power converter 210-2 includes a positive DC bus 215-2p and a negative DC bus 215-2n. The system 200 also includes a DC link 218 that is electrically connected to the inverter 219-1 and the inverter 219-2.

The system 200 also includes a control system 240 that controls the inverters 219-1 and 219-2 based on a control scheme 350. The control scheme 350 includes an operating frequency module 360, which mitigates circulating currents at the operating frequency of the load 202, and a switching frequency module 370, which mitigates circulating currents at the switching frequency of the inverters 219-1 and 219-2.

An overview of the system 200 is provided prior to discussing the control scheme 350 in more detail.

The load 202 is any three-phase load. For example, the load 202 may be a three-phase motor, such as an induction motor or a permanent magnet synchronous machine, an AC power grid, an AC-to-DC power converter, or an AC-to-AC power converter, just to name a few. The DC current source 217 may be, for example, a rectifier that converts an AC current from a three-phase AC source (such as a node in an electrical power distribution network that distributes three-phase AC electrical power having a fundamental frequency of, for example, 50 or 60 Hertz (Hz)). The rectifier may be a diode-based rectifier that converts AC current to DC current or an active front end (AFE) that is controllable to convert AC current to DC current and vice versa. Moreover, although one DC current source 217 is shown in FIG. 2, in some implementations, the power converter 210-1 and the power converter 210-2 each include a rectifier that converts AC current into DC current that is provided to the common DC link 218.

The DC link 218 includes one or more devices that are configured to store electrical energy. For example, the DC link 218 may be a capacitor or a network of capacitors. The inverter 219-1 includes a network of electronic switches S1-1 to S6-4 that are controlled by the control system 240 to generate the AC voltages. Each of the switches S1-1 to S6-4 may be, for example, a power transistor. The inverter 219-1 converts the DC power stored in the DC link 218-1 into three-phase AC voltage (ua1, ub1, uc1).

The power converters 210-1 and 210-2 are identical, and the power converter 210-2 is configured in the same manner as the power converter 210-1. Each phase of the output of the inverter 219-1 and the inverter 219-2 is connected to one phase of the output of the drive apparatus 205 through an output inductor. Specifically, the a-phase, b-phase, and c-phase of the output of the inverter 219-1 is connected the a-phase, b-phase, and c-phase output of drive apparatus 205 through a respective output inductor 213a1, 213b1, and 213c1. The a-phase, b-phase, and c-phase output of the inverter 219-2 is connected to the a-phase, b-phase, and c-phase output of the drive apparatus 205 through a respective output inductor 213a2, 213b2, and 213c2.

The system 200 also includes a sensor system 238 that measures and/or estimates properties or parameters. For example, the sensor system 238 may include current sensors that measure the amount of current drawn in each phase of the load 202; the currents at the outputs of the inverters 219-1 and 219-2; voltage sensors that measure the voltages ua1, ub1, uc1 at the output of the inverter 219-1; the voltages ua2, ub2, uc2 at the output of the inverter 219-2; the voltages ua, ub, uc at the output of the drive apparatus 205; and/or a voltage sensor that measures the voltage across the DC link 218.

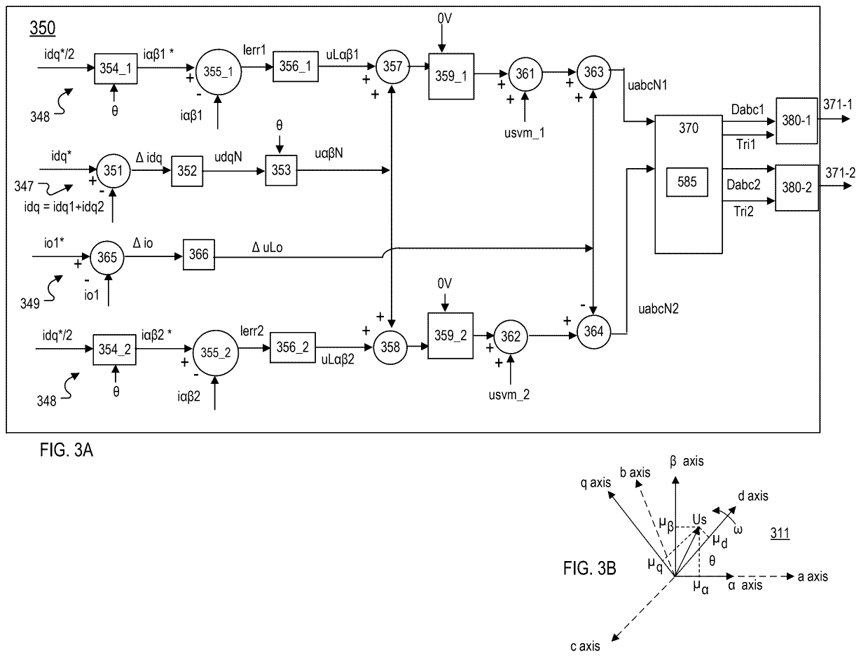

The control system 240 controls the switching pattern of the switches S1-1 to S6-4 and the switches S1-2 to S6-2 to generate respective AC voltages ua1, ub1, uc1 and ua2, ub2, uc2 with particular characteristics (for example, amplitude, frequency, and/or phase). The control system 240 implements the control scheme 350, which is discussed with respect to FIG. 3A.

The control system 240 includes an electronic processing module 242, an electronic storage 244, and an input/output (I/O) interface 246. The electronic processing module 242 includes one or more electronic processors. The electronic processors of the module 242 may be any type of electronic processor and may or may not include a general-purpose central processing unit (CPU), a graphics processing unit (GPU), a microcontroller, a field-programmable gate array (FPGA), Complex Programmable Logic Device (CPLD), and/or an application-specific integrated circuit (ASIC).

The electronic storage 244 may be any type of electronic memory that is capable of storing data and instructions in the form of computer programs or software, and the electronic storage 244 may include volatile and/or non-volatile components. The electronic storage 244 and the processing module 242 are coupled such that the processing module 242 is able to access or read data from and write data to the electronic storage 244. The electronic storage 244 stores instructions that, when executed, cause the electronic processing module 242 to analyze data and/or retrieve information. The electronic storage 244 includes executable instructions to implement various transformations, such as, for example, the Clarke transformation, the Park transformation, and inverse versions of these transformations. Additionally, the electronic storage 244 stores executable instructions that implement the control scheme 350 and the modules 360 and 370 as software, subroutines, functions, or computer programs. The electronic storage 244 also may store values used in the control scheme 350 such as target or reference values and/or thresholds.

The I/O interface 246 may be any interface that allows a human operator and/or an autonomous process to interact with the control system 240. The I/O interface 246 may include, for example, a display (such as a liquid crystal display (LCD)), a keyboard, audio input and/or output (such as speakers and/or a microphone), visual output (such as lights, light emitting diodes (LED)) that are in addition to or instead of the display, serial or parallel port, a Universal Serial Bus (USB) connection, and/or any type of network interface, such as, for example, Ethernet. The I/O interface 246 also may allow communication without physical contact through, for example, an IEEE 802.11, Bluetooth, or a near-field communication (NFC) connection. The control system 240 may be, for example, operated, configured, modified, or updated through the I/O interface 246.

The I/O interface 246 also may allow the control system 240 to communicate with components in the system 200 and with systems external to and remote from the system 200. In another example, the I/O interface 246 may include a communications interface that allows communication between the control system 240 and a remote station (not shown), or between the control system 240 and a separate monitoring apparatus. The remote station or the monitoring apparatus may be any type of station through which an operator is able to communicate with the control system 240 without making physical contact with the control system 240. For example, the remote station may be a computer-based work station, a smart phone, tablet, or a laptop computer that connects to the control system 240 via a services protocol, or a remote control that connects to the control system 240 via a radio-frequency signal.

In operational use of the system 200, two types of circulating currents can flow in the drive apparatus 205. The first type of circulating current is an AC current that includes a frequency component at or near the operating frequency of the load 202. The operating frequency of the load 202 is relatively low, for example, 400 Hz or less. The first type of circulating current may be referred to as a low frequency circulating current or the operating frequency circulating current. The operating frequency circulating current includes a phase circulating current and a zero-sequence circulating current. The phase circulating current flows in a particular phase of both inverters 219-1 and 219-2 and in the DC link 218. For example, an a-phase circulating current may flow through the switch S1-1, the output inductor 213a1, the output inductor 213a2, the switch S4-2, and the DC link 218. Phase circulating currents also may exist in the b-phase and/or the c-phase. The zero-sequence circulating current flows in all phases of the inverter 219-1 and the inverter 219-2 and through the DC link 218.

The second type of circulating current is at the switching frequency of the inverters 219-1 and 219-2 and may be referred to as the high frequency or switching frequency circulating current. The switching frequency circulating current is an AC current that includes a component at or near the frequency at which the switches in the inverters 219-1 and 219-2 are commanded to switch. The switching frequency is generally much higher than the operating frequency and may be, for example, 4 kHz or greater. The switching frequency circulating current is a cross-circulating current that travels between phases of the inverters 219-1 and 219-2 and flows through the DC link 218. For example, the switching frequency circulating current may flow through the switch S1-1 and into the output inductor 213a1 of the inverter 219-1, into the output inductor 213a1 and the switch S4-2, and then into the switches S6-2 and S2-2, through the inductors 213b2 and 213c2, the inductors 213b1 and 213c1, the switches S6-1 and S2-1, and then into the DC link 218. In this way, the switching frequency circulating current flows in more than one phase of the inverters 219-1 and 219-2 and in the DC link 218.

FIG. 3A is a block diagram of the control scheme 350. The control scheme 350 is discussed with respect to FIG. 3A to provide an example. However, the control scheme 350 can be applied to any drive module that includes N parallel inverters that share a common DC link, where N is an integer number that is greater than or equal to 2.

The sensor system 238 measures the current or voltage at the output of each phase of the inverters 219-1 and 219-2. The phase currents at the output of the inverter 219-1 are ia1, ib1, and ic1 and the phase currents at the output of the inverter 219-2 are ia2, ib2, and ic2. Referring also to FIG. 3B, which is a representation 311, the phase currents at the output of each of the inverter 219-1 (ia1, ib1, ic1) and the inverter 219-2 (ia2, ib2, ic2) are transformed into two orthogonal current components: a component iα along the α axis and a component iβ along the β axis (which is orthogonal to the α axis) using the Clarke transformation. The Clarke transformation projects a three-phase quantity (such as a three-phase current or voltage) onto a two-dimensional stationary coordinate system defined by the α axis and the β axis. The Clarke transformation is shown in Equation (1):

$${i}_{αβo} = [ \begin{matrix}1 & - \frac{1}{2} & - \frac{1}{2} \\ 0 & \frac{\sqrt[]{3}}{2} & - \frac{\sqrt[]{3}}{2} \\ \frac{1}{2} & \frac{1}{2} & \frac{1}{2}\end{matrix} ] [ \begin{matrix}{i}_{a} \\ {i}_{b} \\ {i}_{c}\end{matrix} ] , \qquad Equation ( 1 )$$

where ia, ib, ic are the instantaneous currents output by the inverter 219-1 or 219-2, and i_{αβ} is a vector that includes a component along the α axis and a component along the β axis. The vector also includes an o-axis component that is zero when the current is balanced in all three phases a,b,c. The current is balanced when each phase a, b, c, has the same amplitude and each phase a,b,c is 120° out of phase with the other phases.

The vector i_{αβo} is transformed into dq coordinates by the Park transformation. The Park transformation is shown in Equation (2):

$$idqo = [ \begin{matrix}id \\ iq \\ io\end{matrix} ] = [ \begin{matrix}cos ( θ ) & sin ( θ ) & 0 \\ - sin ( θ ) & cos ( θ ) & 0 \\ 0 & 0 & 1\end{matrix} ] [ \begin{matrix}i α \\ i β \\ io\end{matrix} ] , \qquad Equation ( 2 )$$

where idqo is a vector that includes a component along the d axis (id, or the observed d-axis current), a component along the q axis (iq, or the observed q-axis current), and an o-axis component (io), and θ is the observed angular position (θo) of the load 202. For example, in implementations in which the load 202 is a motor, the observed angular position (θo) is the position of the rotor. The idq vector represents an observed output current with a component on the d-axis and a component on the q-axis and is determined for the inverter 219-1 (idq1) and for the second inverter 219-2 (idq2).

The circulating currents do not flow through the load 202. Thus, the control scheme 350 controls the current to the load 202 and the circulating currents separately. The load 202 sees the sum of the output currents of the paralleled inverters 219-1 and 219-2. To control the current to the load 202, the target current (idq*) for the load 202 is compared to the observed current (idq) output by the drive apparatus 205 at a load control path 347. The observed current (idq) is the sum of the observed output of the inverter 219-1 (idq1) and the observed output of the inverter 219-2 (idq2), as shown in Equation (3):

$$idq = idq 1 + idq 2. \qquad Equation ( 3 )$$

The target current (idq*) is compared to the observed inverter output current (idq) at a summation junction 351, which subtracts idq from idq* to output Δidq. The output of the summation junction 351 (Δidq) is provided to a complex vector proportional-integral (PI) controller 352. The complex vector PI controller 352 minimizes Δidq and outputs the average output voltage available for the load 202 (udq_avg), which is expressed in Equation (4):

$${μ}_{dq}^{avg} = \frac{( {sL}_{cs} + {R}_{cs} ) {i}_{dq}}{2} + {μ}_{dqN} , \qquad Equation ( 4 )$$

where Lcs is the average inductance of the inverter output inductors, Rcs is the equivalent resistance of the inverter output inductors 213, and udqN is the output voltage of the drive apparatus 205. The voltage (udq_avg) is converted into an αβ vector (uαβN) at a transformation block 353, which implements an inverse Park transformation. The αβ load voltage (uαβN) is provided to summation blocks 357 and 358.

As noted above, the circulating currents do not flow in the load 202 and are controlled separately from the current to the load 202. The circulating current at the operating frequency of the load 202 includes an αβ-axis circulating current and an o-axis circulating current. The operating frequency module 360 controls these currents to zero or reduces them toward zero with an alpha-beta axis (αβ-axis) current control path 348 for each inverter 219-1, 219-2 and an o-axis current control path 349.

The o-axis current control path 349 is discussed first. The o-axis circulating current is controlled to zero by minimizing the difference between a target o-axis circulating current (io1*) and an observed o-axis circulating current. To eliminate the o-axis circulating current, the target o-axis circulating current (io*) is set to zero. The observed o-axis current (io1) is determined from the measured output current of the inverter 219-1 and Equation (5):

$$io 1 = \frac{ia 1 + ib 1 + ic 1}{3} , \qquad Equation ( 5 )$$

where ia1, ib1, ic1 are the measured three-phase output currents of the inverter 219-1. The difference between the target o-axis current (io*) and the observed o-axis current (io1) is determined at a summing junction 365 to produce an error metric Δio, which is provided to a proportional-integral-resonant (PIR) controller 366. The PIR controller 366 minimizes the error metric Δio and produces the o-axis inverter voltage difference ΔuLo. The o-axis inverter voltage difference ΔuLo is expressed in Equation (6):

$$Δ {μ}_{L o} = \frac{{L}_{m 1} + {L}_{m 2}}{2} \frac{{di}_{o 1}}{dt} + {R}_{cs} {i}_{o 1} , \qquad Equation ( 6 )$$

where Lm1 and Lm2 are the average output inductance of the inverter 219-1 and the inverter 219-2, respectively. The transfer function of the PIR controller 366 is GcPIR(s) and is given in Equation (7):

$${G}_{cPIR} ( s ) = {K}_{p} + \frac{{K}_{i}}{s} + \frac{{K}_{r} s}{{s}^{s} + {ω}_{e}^{2}} , \qquad Equation ( 7 )$$

where wₑ is the resonant frequency, Kp is the proportional gain, Ki is the integral gain, and Kr is the resonant gain. The o-axis inverter voltage difference ΔuLo is provided to summing junctions 363 and 364.

The αβ-axis current control path 348 is discussed next. The target output current for the load 202 is (idq*). Under ideal conditions, the output of the inverter 219-1 is the same as the output of the inverter 219-2 and the total output of the drive apparatus 205 is the sum of the output of the inverters 219-1 and 219-2. Thus, the target output current for each inverter 219-1, 219-2 is (idq*/N), where N is the total number of paralleled inverters that share a common DC link. The dq target inverter output current for each inverter 219-1, 219-2 (iqd*/2 in this example) is converted into a target alpha-beta inverter current (i_{αβ1}*), which is a vector that includes a component along the α axis and a component along the β axis, at a respective transformation block 354_1, 354_2. Each of the transformation blocks 354_1, 354_2 implements the inverse Park transformation. The observed alpha-beta current at the output of the inverter 219-1 (i_{αβ1}) is compared to the target alpha-beta current for the inverter 219-1 (i_{αβ1}*) at a summation junction 355_1 that subtracts the observed current (i_{αβ1}*) from the target current to produce a current error metric (Ierr1) as shown in Equation (8):

$$Ierr 1 = i α β {1}^{*} - i α β 1. \qquad Equation ( 8 )$$

Similarly, the observed alpha-beta current at the output of the inverter 219-2 (i_{αβ2}) is compared to the target alpha-beta current for the inverter 219-2 (i_{αβ2}*) at a summation junction 355_2 that subtracts the observed current (i_{αβ2}*) from the target current for the inverter 219-2 (i_{αβ2}*) to produce a current error metric (Ierr2).

The current error metric Ierr1 is provided to a current controller 3561, and the current error metric Ierr2 is provided to a current controller 356_2. Each current controller 3561, 356_2 is a proportional, integral, and resonant (PIR) controller with a transfer function as shown in Equation (7). The current controller 356_1 reduces the current error metric (Ierr1) and produces the voltage (uLαβ1) across the output inductor of the inverter 219-1. The current controller 356_2 reduces the current error metric (Ierr2) and produces the inductance voltage (uLαβ2) across the output inductor of the inverter 219-2.

The voltage (uLαβ1) of the inverter 219-1 is added to the voltage for the load 202 (uαβN) from the motor current control path 347 at a summation block 357 to produce the output voltage of the inverter 219-1 (uαβ1N). The voltage (uLαβ2) of the inverter 219-2 is added to the load voltage (uαβN) from the motor current control path 347 at a summation block 358 to produce the output voltage of the inverter 219-2 (uαβ2N).

Each of (uαβ1N) and (uαβ2N) is provided to a respective transformation block 359_1, 359_2 that implements an inverse of the Clarke transformation to determine the three-phase output voltage (uabc1) of the inverter 219-1 and the three-phase output voltage (uabc2) of the inverter 219-2. The respective three-phase voltages (uabc1) and (uabc2) are added to a space vector modulation voltage (usvm_1) and (usvm_2) at respective summation junctions 361, 362. The space vector modulation voltage is given by Equation (9a):

$${μ}_{k}^{SVM} = - [ max ( {μ}_{abck} ) + min ( {μ}_{abck} ) ] / 2 , \qquad Equation ( 9 a )$$

where uabck is the inverter output voltage for the kth parallel inverter, and k indexes the inverter (k=1 and 2 for the implementation that includes two inverters 219-1 and 219-2). In some implementations, the respective three-phase voltages (uabc1) and (uabc2)) are added to the same space vector modulation voltage by finding the average space modulation vector using Equation (9b):

$${μ}_{o}^{SVM} = [ {μ}_{01}^{SVM} + {μ}_{02}^{SVM} ] / 2 , \qquad Equation ( 9 b )$$

where each term in the numerator on the right-hand side of the equation is found using Equation (9a).

The output of the summation junction 361 is added to the o-axis inverter voltage difference ΔuLo from the o-axis circulating current control 348 at a summation junction 363 to produce uabc1N, which is the three-phase output voltage of the inverter 219-1 with removed or reduced the low-frequency circulating current. The output of the summation junction 362 is provided to a summation junction 364. The summation junction 364 subtracts the o-axis inverter voltage difference ΔuLo from uabc2 to produce uabc2N, which is the three-phase output voltage of the inverter 219-2 with removed or reduced low-frequency circulating current.

The output of each junction 363 (uabc1N) and 364 (uabc2N) is input into a switching frequency module 370. The switching frequency module 370 removes or reduces high-frequency cross-circulating current. The cross-circulating current is caused by asynchronous PWM switching events in the paralleled power converters 210-1 and 210-2. The switching frequency module 370 compensates the carrier wave used to generate gate commands for the inverter 219-1 and/or the inverter 219-2 to mitigate or eliminate asynchronous switching events.

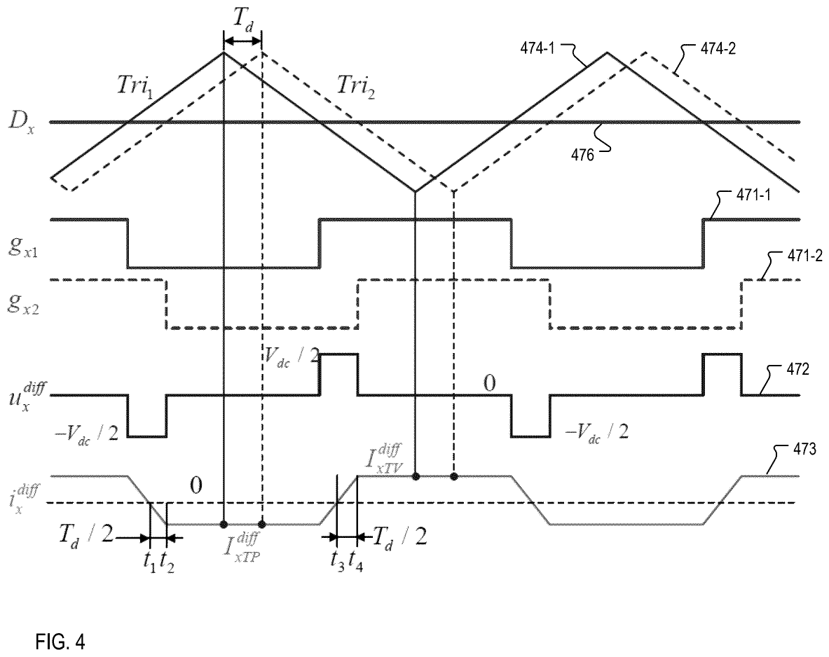

FIG. 4 is a graphical example of switching events as a function of time of any one of the three phases in each inverter 219-1 and 219-2. FIG. 4 includes representations of an AC phase reference wave 476, a first inverter 219-1 carrier wave Tri1 474-1, and a second inverter 219-2 carrier wave Tri2 474-2. The carrier waves Tri1 474-1 and Tri2 474-2 are triangle waves having a fundamental frequency at the switching frequency of the inverters 219-1 and 219-2. The reference wave 476 varies over time at the operating frequency of the load 202. The operating frequency of the load 202 is much lower than the switching frequency of the controllable switches in the inverters 219-1 and 219-2. For example, the operating frequency of the load 202 may be 60 Hz and the switching frequency of the inverters 219-1, 219-2 may be 4 kHz. The time span shown in FIG. 4 is much less than one cycle of the load 202, and, thus, the amplitude of the phase reference wave 476 over the time period shown in FIG. 4 is essentially constant. To provide a more specific example, one cycle of a load 202 operated at 60 Hz is 16.6 milliseconds (ms), whereas FIG. 4 shows about two cycles of the carrier waves Tri1 474-1, Tri2 474-2, and each cycle of the carrier waves Tri1 474-1, Tri2 474-2 may be about 250 microseconds (μs). Thus, although the amplitude of the reference wave 476 varies over time, its amplitude is nearly constant over the time span shown in FIG. 4.

FIG. 4 also shows a gate command 471-1 for a switch in an x phase the first inverter 219-1 and a gate command 471-2 for a switch for the x phase in the second inverter 219-2, where the x phase is the a phase, b phase, or c phase. For example, if the x phase is the c phase, the gate command 471-1 controls the c-phase switch S5-1 in the first inverter 219-1, and the gate command 471-2 for the c-phase switch S5-2 in the second inverter 219-2. Each gate command 471-1, 471-2 is a digital voltage signal that controls the state of a switch in the x phase. For example, when the gate command 471-1 is the c phase and is HIGH, the c-phase switch S5-1 is ON.

The intersection of the carrier wave Tri1 474-1 with the phase reference wave 476 defines the gate command 471-1. For example, the rightmost transition of the gate command 471-1 corresponds in time with the intersection of the carrier wave Tri1 474-1 with the phase reference wave 476. The immediately subsequent transition of the gate command 471-1 occurs when the carrier wave Tri1 474-1 intersects and falls below the phase reference wave 476. Similarly, the intersection of the carrier wave Tri2 474-2 with the phase reference wave 476 defines the gate command 471-2. For example, the rightmost transition of the gate command 471-2 occurs when the carrier wave Tri2 474-2 intersects the phase reference wave 476. The immediately subsequent transition of the gate command 471-2 occurs when the carrier wave Tri2 474-2 intersects and falls below the phase reference wave 476. The gate commands 471-1, 471-2 are defined by the intersection of the respective carrier wave Tri1 474-1, Tri2 474-2 with the phase reference wave 476.

In the example of FIG. 4, there is a delay (Td) between the carrier wave Tri1 474-1 and the carrier wave Tri2 474-2. The delay (Td) corresponds to a delay between the gate commands 471-1, 471-2. During the time periods in which the gate commands for a particular phase are not synchronized, the output voltage and the output current of the inverters 219-1 and 219-2 is also unequal. As shown in FIG. 4, the inverter output voltage difference 472 is non-zero at time periods that correspond to an amplitude difference between the gate commands 471-1 and 471-2 and at time periods that correspond to an amplitude difference between the gate commands 471-1 and 471-2. FIG. 4 shows the circulating current between the inverters 219-1 and 219-2 labeled as 473.

The phase x circulating currents at the PWM carrier peak (maximum) and valley (minimum) are represented in Equations (10) to (13):

$${I}_{xTP}^{diff} = - \frac{{V}_{dc} {T}_{d}}{4 {L}_{cs}} , \qquad Equation ( 10 )$$

$${I}_{xTV}^{diff} = \frac{{V}_{dc} {T}_{d}}{4 {L}_{cs}} , \qquad Equation ( 11 )$$

where x is any of the phases (a, b, or c), Idiff_xTP is the value of the circulating current in phase x at the peak of the PWM carrier wave, I_diff_xTV is the value of the circulating current in phase x at the valley of the PWM carrier wave, Vdc is the voltage across the common DC link 218, Td is the time delay or phase shift between a point on Tri1 474-1 (the carrier wave for the inverter 219-1) and a corresponding point on Tri2 474-2 (the carrier wave for the inverter 219-2), and Lcs is the nominal inductance of the output inductors 213. The high-frequency circulating current in phase x (Idiff_xm) is due to the PWM carrier shift (the delay Td between Tri1 474-1 and Tri2 474-2) and is represented in Equations (12) and (13):

$${I}_{xm}^{diff} = \vert {I}_{xTP}^{diff} - {I}_{xTV}^{diff} \vert = \frac{{V}_{dc} {T}_{d}}{2 {L}_{cs}} , \qquad Equation ( 12 )$$

$$Td = - \frac{2 {L}_{CS}}{{V}_{DC}} ( {I}_{xTP}^{diff} - {I}_{xTV}^{diff} ) . \qquad Equation ( 13 )$$

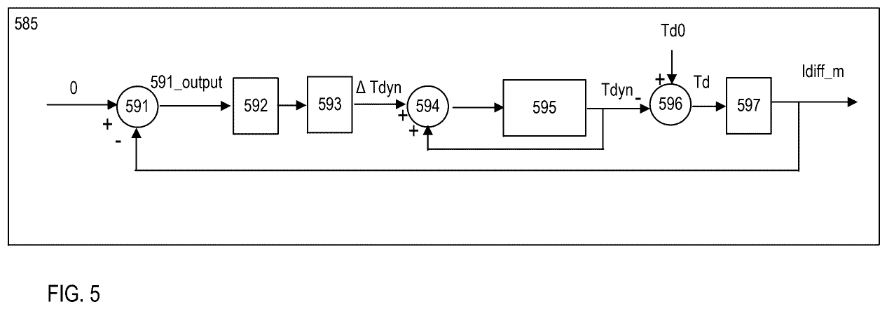

FIG. 5 is a block diagram of a compensation block 585 used in the switching frequency module 370. In the compensation block 585, Td0 is the time that the inverter carrier wave Tri2 474-2 lags behind the inverter carrier wave Tri1 474-1 before compensation, ΔTdyn is the time that the inverter carrier wave Tri1 474-1 lags behind the inverter carrier wave Tri2 474-2 after each compensation, Tdyn is the total time lag of the carrier Tri1 474-1, and Td=Td0−Tdyn is the time that the carrier wave Tri2 474-2 lags behind the carrier wave Tri1 474-1 after each compensation step.

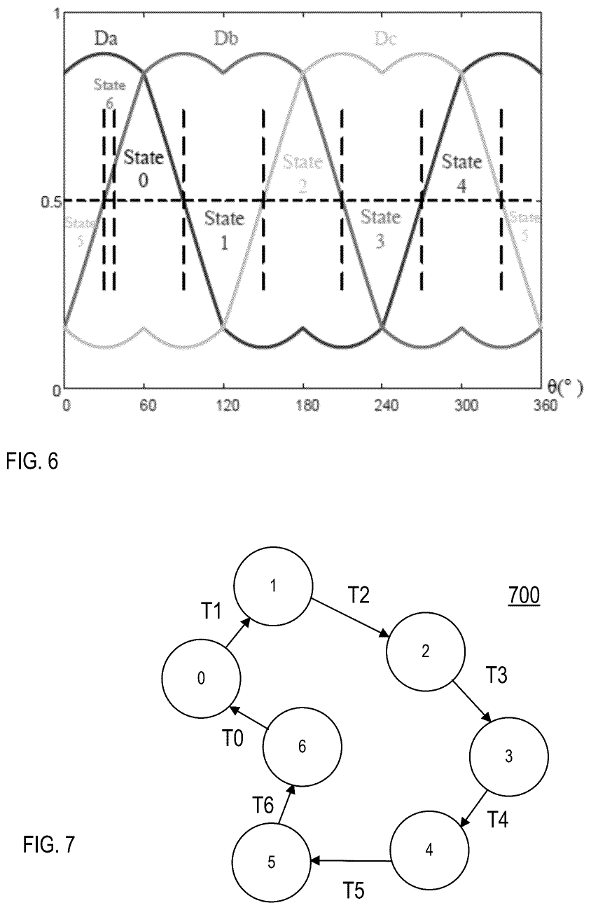

The compensation block 585 seeks to eliminate the high-frequency circulating current by minimizing an average current feedback signal, Idiff_m. FIGS. 6 and 7 discuss the average current feedback signal Idiff_m. FIG. 6 shows an example of Da (the phase-a reference signal), Db (the phase-b reference signal), and Dc (the phase-c reference signal) over a single period (360°) of the operating frequency of the load 202. A carrier wave is not shown in FIG. 6 but may be a triangle wave (such as Tri1 474-1 and Tri2 474-2) with a much higher frequency than the reference signals Da, Db, Dc. FIG. 7 is a state machine 700 for sampling the inverter output currents based on the reference signals Da, Db, Dc and determining the average current feedback signal Idiff_m. The state machine 700 includes 7 states: state 0, state 1, state 2, state 3, state 4, state 5, and state 6. The states are also labeled on FIG. 6. The state machine 700 also includes transitions T0 to T6 that define the transitions between states.

In state 0, the peak (or maximum) of the carrier wave Tri1 is detected and the phase-a circulating current at the time of the peak is sampled and saved as Idiff_aTP1. The phase-a circulating current is the difference between the phase-a output current of the inverter 219-1 and the phase-a output current of the inverter 219-2. The phase-a circulating current may be sampled by obtaining a measurement of ia1 and a measurement of ia2 and finding the difference between these two currents. The valley (or minimum) of the carrier wave Tri1 is detected and the phase-a circulating current is sampled and saved as Idiff_aTV1. The state machine 700 transitions from state 0 to state 1 when conditions associated with transition T1 are true. The conditions associated with the transition T1 are true when the amplitude of the reference Da is decreasing with the previous sampled value of the reference Da being greater than 0.5 and the next value being less than or equal to 0.5. In state 1, the phase-c circulating current is sampled in response to detecting the peak of the carrier wave Tri1 and saved as Idiff_cTP1. The phase c-circulating current is sampled in response to detecting the minimum of the carrier wave Tri1 and saved as Idiff_cTV1. When the amplitude of the reference Dc is increasing with the previous sampled value of the reference Dc being less than 0.5 and the next sampled value of Dc is greater than or equal to 0.5, the conditions of the transition T2 are true and the state machine 700 transitions to state 2. In state 2, the phase-b circulating current is sampled in response to detecting the peak of the carrier wave Tri1 and saved as Idiff_bTP1. The phase-b circulating current is sampled in response to detecting the minimum of the carrier wave Tri1 and saved as Idiff_bTV1. When the amplitude of the reference Db is decreasing with the previous sampled value of the reference Dc being greater than 0.5 and the next value of Db is less than or equal to 0.5, the conditions of the transition T3 are true and the state machine 700 transitions to state 3.

States 3, 4, and 5 are in the reverse direction of States 0, 1, and 2, respectively. States 3, 4, and 5 sample the circulating current in each phase a, b, and c at the peak and valley of the carrier wave Tri1. In state 3, the peak of the carrier wave Tri1 is detected and the phase-a circulating current is sampled and saved as Idiff_aTP2. The valley of the carrier wave Tri1 is detected and the phase-a circulating current is sampled and saved as Idiff_aTV2. When the amplitude of the reference Da is increasing with the previous sampled value of the reference Da being less than 0.5 and the next value of Da is greater than or equal to 0.5, the conditions of the transition T4 are true and the state machine 700 transitions to state 4. In state 4, the phase-c circulating current is sampled in response to detecting the peak of the carrier wave Tri1 and saved as Idiff_cTP2. The phase-c circulating current is sampled in response to detecting the minimum of the carrier wave Tri1 and saved as Idiff_cTV2. When the amplitude of the reference Dc is decreasing with the previous sampled value of the reference Dc being greater than 0.5 and the next value of Dc is less than or equal to 0.5, the conditions of the transition T5 are true and the state machine 700 transitions to state 5. In state 5, the phase-b circulating current is sampled in response to detecting the peak of the carrier wave Tri1 and saved as Idiff_bTP2. The phase-b circulating current is sampled in response to detecting the minimum of the carrier wave Tri1 and saved as Idiff_bTV2. When the amplitude of the reference Db is increasing with the previous sampled value of the reference Db being less than 0.5 and the next value of Db is greater than or equal to 0.5, the conditions of the transition T6 are true and the state machine 700 transitions to state 6.

In state 6, the values sampled in states 0 to 5 are used to calculate the average current feedback signal Idiff_m based on Equation (14):

$${I}_{m}^{diff} = {I}_{TP}^{diff} - {I}_{TV}^{diff} = \frac{{\sum }_{x = a , b , c} ( {1}_{xTP 1}^{diff} - {1}_{xTV 1}^{diff} ) + {\sum }_{a , b , c} ( {1}_{xTP 2}^{diff} - {1}_{XTV 2}^{diff} )}{6} . \qquad Equation ( 14 )$$

The average current feedback signal Idiff_m is an estimate or determination of the high-frequency circulating current. After Idiff_m is determined, the state machine 700 transitions to state 0 to calculate the average current feedback signal Idiff_m for the next cycle.

Returning to FIG. 5, the compensation block 585 compares the average current feedback signal Idiff_m to zero (0) at a summing junction 591. Specifically, the output of the summing junction 591 (591_output) is the quantity represented by Equation (15):

$$591 \_output = 0 - {I}_{m}^{diff} . \qquad Equation ( 15 )$$

The output (591_output) of the summing junction 591 is provided to a block 592 that implements Equation (16):

$$\frac{2 {L}_{CS}}{{V}_{DC}} . \qquad Equation ( 16 )$$

The block 592 multiplies (591_output) by the quantity represented by Equation (16) and provides the output to an adjustable gain block 593, which applies an adjustable gain. The adjustable gain may be greater than 0 and less than 1. The output of the adjustable gain block 593 is ΔTdyn, which is provided to a summing junction 594 and integrator 595 to determine Tdyn. The output of the integrator 595 (Tdyn) is fed back to the summing junction 594, which adds Tdyn to ΔTdyn to determine the total lag time of Tri1 compared to the original Tri1 after phase correction. The time delay (Td) is determined at a junction 596, which subtracts Tdyn from Td0 to determine the time delay (Td). The determined time delay (Td) is provided to a block 597, which multiples Td by the quantity represented in Equation (17):

$$- \frac{{V}_{DC}}{2 {L}_{CS}} . \qquad Equation ( 17 )$$

To provide a more specific example of the use of the compensation block 585, if the time delay before compensation (Td0) is 10 μs and the switching frequency is 4 kHz, the compensation block 585 reduces this initial time delay of 10 μs to nearly zero by calculating a new time delay (Td) value in each 4 kHz switching frequency period. The value of the time delay (Td) is reduced with each iteration and the carrier wave Tri1 474-1 and/or Tri2 474-2 delayed or advanced by Td. This process of iterating to reduce Td continues until the time delay (Td) is reduced to zero or nearly zero. In implementations in which the time delay (Td) is reduced to nearly zero, a threshold value of Td may be pre-defined and stored on the electronic storage 244. The compensation performed by the compensation block 585 results in the gate commands 471-1, 471-2 being in phase. In this way, the switches in each phase of the inverter 219-1 transition state at the same time as the corresponding switches in each phase of the inverter 219-2.

Referring again to FIG. 3A, the output of the switching frequency module 370 is Dabc1 and Dabc2, which are the reference waveforms for the inverter 219-1 and 219-2 respectively, and carrier waves Tri1 and/or Tri2. The carrier wave Tri1 and/or Tri2 is phase shifted by the compensation block 585 in the manner discussed above. The reference waveform Dabc1 and the carrier wave Tri1 from the module 370 are input to a PWM block 380-1. The reference waveform Dabc1 includes a reference for each phase a, b, c. The PWM block 380-1 generates gate commands 371-1 for each phase of the first inverter 219-1 by comparing each phase of the reference waveform Dabc1 to the carrier wave Tri1 as discussed above. The reference waveform Dabc2 and the carrier wave Tri2 from the module 370 are input into a PWM block 380-2. The PWM block 380-2 generates gate commands 371-2 for each phase of the second inverter 219-2 by comparing each phase of the reference waveform Dabc2 to the carrier wave Tri2. Because the carrier wave Tri1 and/or Tri2 have been phase shifted, when the respective resulting gate commands 371-1, 371-2 are applied to the respective inverters 219-1 and 219-2, the inverters 219-1 and 219-2 generate the target voltage and/or current for the load 202 and the circulating currents in the drive apparatus 205 are reduced or eliminated.

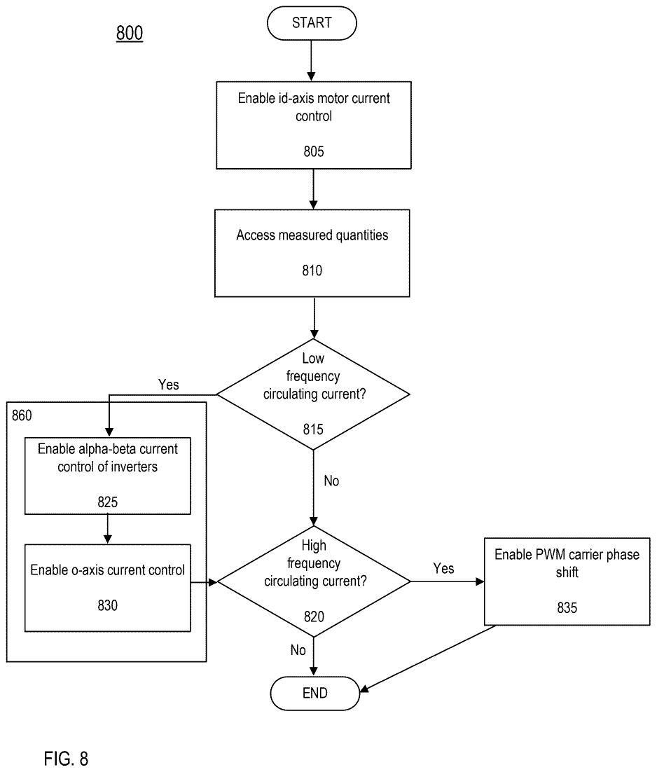

FIG. 8 is a flowchart of a process 800. The process 800 is an example of a process for controlling current to a load and removing or reducing circulating currents in a drive apparatus that includes N paralleled inverters that share a common DC link, where N is an integer number that is greater than or equal to two. The process 800 may be performed by the control system 240 and the control scheme 350. Although the process 800 may be used with any apparatus that includes N paralleled inverters that share a common DC link, the process 800 is discussed with respect to the drive apparatus 205.

The process 800 enables dq-axis motor current control (805). The dq-axis motor current control may be performed by the control path 347 (FIG. 3A) as discussed above. Measured values of the drive apparatus 205 are accessed (810). The measured values may be measurements obtained by the sensor system 238. The measured values include the output three-phase current (ia, ib, ic) and/or voltage (ua, ub, uc) at the output of the drive apparatus 205, the three-phase inverter output currents (ia1, ib1, ic1, ia2, ib2, ic2) and/or voltages (ua1, ub1, uc1, ua2, ub2, uc2), the voltage across the DC link 218 (Vdc), and/or measurements from which these values can be derived. The measured values also may include other quantities. The measured values that are three-phase values may be converted into dq-axis and αβ-axis vectors using the Park and Clarke transformations, respectively.

If a low-frequency circulating current exists (815), the process 800 advances to a low-frequency current control sub-process 860. The low-frequency circulating current may include a phase circulating current and/or an o-axis circulating current. If either of these circulating currents exists, a low-frequency circulating current exists. To determine whether a phase circulating current exists, the measured αβ-axis output current of each inverter 219-1 and 219-2 is provided to the respective summation junction 355_1 and 355_2 and compared to the reference iαβ* current as shown in FIG. 3A. If the measured αβ-axis output current of the inverter 219-1 and 219-2 exceeds the reference, the control path 348 is activated to mitigate the phase circulating current (825). The measured o-axis circulating current is determined based on Equation (5) and compared to io1*, as shown in FIG. 3A. If the measured o-axis current exceeds io1*, then the o-axis current control path 349 is activated and o-axis inverter voltage difference ΔuLo (830). If the measured o-axis current does not exceed io1*, the o-axis inverter voltage difference ΔuLo is set to zero.

After the low-frequency circulating current mitigation is performed and/or if there is no low-frequency circulating current, the process 800 determines whether a high-frequency circulating current exists in the drive apparatus 205 (820). A high-frequency circulating current may be determined to exist if the average current feedback signal (Idiff_m) shown in Equation (14) is non-zero or exceeds a pre-determined non-zero threshold. If the high-frequency circulating current exists, it is mitigated by the switching frequency module 370 as discussed above with respect to FIGS. 3A, 5, 6, and 7. After the high-frequency circulating current is mitigated, the process 800 ends or returns to (805) to continue monitoring for and removing circulating current while performing the motor control path 347. If there is no high-frequency circulating current at (820), the PWM carrier waves are not phase shifted, and the process 800 ends or returns to (805) to continue monitoring for and removing circuiting current while performing the motor control path 347.

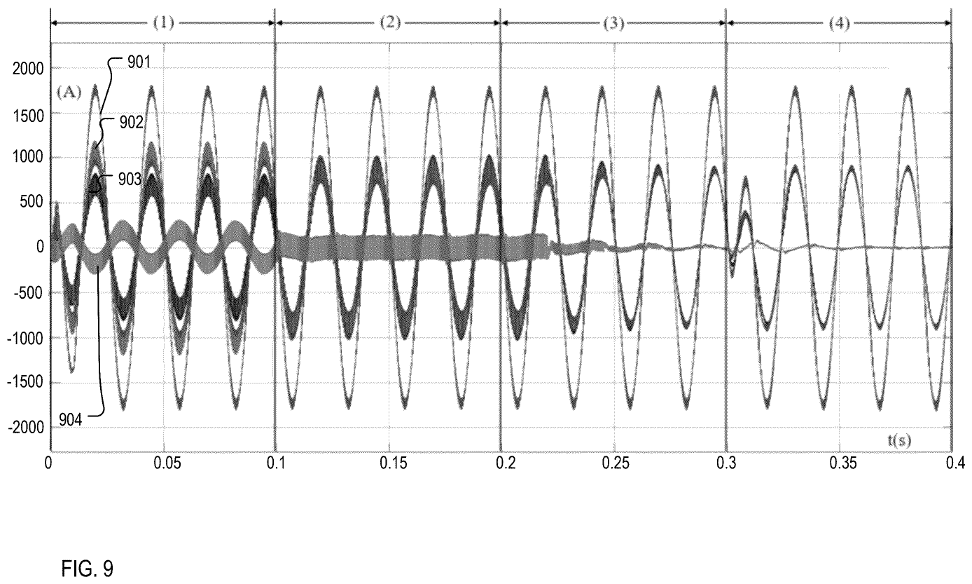

FIG. 9 shows simulated results from a simulated system that included two paralleled ASDs at 500 horsepower (HP), 370 kiloWatts (kW), 590 A each and a control system that implemented the control scheme 350 and/or the process 800. The paralleled ASDs shared a common DC link. In FIG. 9, the plot labeled 901 is the sum of the phase-a output current of the first ASD and the phase-a output current of the second ASD as a function of time, the plot labeled 902 is the phase-a output current of the second ASD as a function of time, the plot labeled 903 is the phase-a output current of the first ASD as a function of time, and the plot labeled 904 is (Idiff_a) the difference between the phase-a output current of the first ASD and the phase-a output current of the second ASD. In the simulation, the phase-a output inductor of the first ASD was 14.7 microHenries (μH) and the phase-a output inductor of the second ASD was 9.8 pH. The PWM carrier for the first ASD (Tri1) lagged behind the PWM carrier for the second ASD (Tri2) by Td=10 μs, Vdc=540 V, and Lcs=12.3 μH. Each ASD was simulated to operate at 80% load and 80% rated load speed.

FIG. 9 includes four sections labeled as follows (1) from 0s to 0.1s: no circulating current mitigation applied, (2) from 0.1s to 0.2s: low-frequency circulating current mitigation applied (for example, the control paths 348 and 349 in FIG. 3A), (3) from 0.2s to 0.3s: low-frequency and high-frequency circulating current mitigation applied (for example, the module 370 and the compensation block 585), (4) from 0.3s to 0.4s: low-frequency and high-frequency circulating current mitigation applied while a dynamic step load reversal occurs at just after 0.3s. As is apparent from comparing section (2) to section (1), the two ASDs share current more equally after the low-frequency mitigation is applied but there is still a high-frequency circulating current (904). In section (3), the high-frequency circulating current is attenuated to nearly zero and the phase-a output currents of both ASDs are nearly the same after the high-frequency circulating current mitigation is applied. Moreover, and as shown in section (4), the mitigation techniques continue to remove the circulating currents even in the presence of a dynamic step load reversal, demonstrating the effectiveness and robust nature of the circulating current mitigation performed by the control system 240.

These and other implementations are within the scope of the claims.

What is claimed is:

1. A system comprising:
a drive module comprising an input, an output, and a plurality of power converters in parallel, each power converter comprising:
an inverter electrically connected to the output of the drive module, the inverter comprising a plurality of controllable switches configured to switch at a switching frequency; and
a common direct current (DC) link electrically connected to the inverter of each power converter; and
a control apparatus coupled to the drive module, the control system configured to mitigate a plurality of circulating currents.

2. The system of claim 1, wherein the plurality of circulating currents comprise a circulating current associated with the switching frequency and a circulating current associated with an operating frequency of a load electrically connected to the drive module.

3. The system of claim 2, wherein
the circulating current associated with the switching frequency comprises a cross-circulating current; and
the circulating current associated with the operating frequency comprises: one or more phase circulating currents, each phase circulating current flowing in one phase of the plurality of power converters and the common DC link; and a zero-sequence circulating current.

4. The system of claim 1, wherein the control apparatus is configured to mitigate a high-frequency circulating current and a low-frequency circulating current.

5. The system of claim 4, wherein, to mitigate the high-frequency circulating current, the control apparatus is configured to minimize an electrical feedback quantity, the electrical feedback quantity based on a difference in an electrical output in one phase of each of the plurality of inverters.

6. The system of claim 5, wherein the electrical output comprises an output current.

7. The system of claim 4, wherein, to mitigate the high-frequency circulating current, the control apparatus is configured phase shift a carrier wave associated with one of the plurality of inverters relative to the carrier wave associated with at least one other of the plurality of inverters.

8. The system of claim 4, wherein, to compensate for the low-frequency circulating current, the control system is configured to minimize a difference in an observed o-axis current.

9. The system of claim 8, wherein, to compensate for the low-frequency circulating current, the control system is further configured to minimize a difference between an observed output of each inverter and a reference based on the sum of the outputs of all of the inverters.

10. The system of claim 9, wherein the observed output is an as output current.

11. A control apparatus comprising:
a cross-circulating current compensation module configured to:
access a measured value of an electrical quantity at each of a plurality of inverters, wherein all of the plurality of inverters are electrically connected to a common DC link;
determine a difference between the accessed measured values;
determine a compensation based on the determined difference; and
adjust a carrier wave of one or more of the plurality of inverters based on the determined compensation; and
an operating frequency circulating current compensation module configured to reduce an amount of circulating current at an operating frequency of a load electrically connected to the plurality of inverters.

12. The control apparatus of claim 11, wherein the compensation comprises a phase shift, and to adjust the carrier wave of one or more of the plurality of inverters, the cross-circulating current compensation module is configured to delay or advance the carrier wave of one or more of the plurality of inverters by the phase shift.

13. The control apparatus of claim 11, wherein the cross-circulating current compensation module is further configured to minimize the difference between the accessed measured values and to determine the compensation based on the minimized difference.

14. A method comprising:
accessing a measured value of an electrical quantity at an output of each of a plurality of inverters, wherein all of the plurality of inverters is electrically connected to a common DC link;
determining a difference between the accessed measured values;
determining a compensation based on minimizing the difference between the accessed measured values;
adjusting a control signal for one or more of the plurality of inverters based on the compensation; and
providing the adjusted control signal to the one or more of the plurality of inverters to reduce the difference between the electrical quantity at the outputs of the inverters.

15. The method of claim 14, wherein the electrical quantity comprises a three-phase current at an output of each of the plurality of inverters, and, after providing the adjusted control signal to the one or more of the plurality of inverters, any one phase of the three-phase output current at a first one of the plurality of inverters is substantially the same in amplitude and phase as that same one phase at any other of the plurality of inverters.

16. A control system for a drive module comprising a plurality of parallel inverters electrically connected to a common direct current (DC) link, the control system configured to:
sample a circulating current in each phase of the drive module in response to detecting a peak of a first carrier wave and in response to detecting a minimum of the first carrier wave;
determine an average circulating current based on the sampled circulating currents; and
reduce the circulating current in the drive module by applying a compensation based on the average circulating current.

17. The control system of claim 16, wherein
the first carrier wave is a carrier wave used to determine a gate signal for a first one of the plurality of inverters;
the control system is further configured to determine the compensation, and the compensation comprises a time difference between the first carrier wave and a second carrier wave used to determine a gate signal for a second one of the plurality of inverters; and
to reduce the circulating current in the drive module, the second carrier wave is adjusted to reduce the time difference.

18. The system of claim 17, wherein the second carrier wave is adjusted by being delayed or advanced by the time difference.

19. The control system of claim 16, wherein to sample the circulating current in each phase, the control system is configured to:
record the circulating current in one phase in response to detecting the peak of the first carrier wave;
record the circulating current in the one phase in response to detecting the minimum of the first carrier wave;
monitor a reference wave associated with the one phase relative to a pre-determined condition; and
transition to sample the circulating current in another phase when the pre-determined condition is met.

20. The control system of claim 19, wherein the circulating current is sampled over one cycle, and a transition occurs six times during the cycle.
